(19) United States
(12) Patent Application Publication
(10) Pub. No.: US 2009/0305105 A1
(43) Pub. Date: Dec. 10, 2009

(54) Fuel cell and method for manufacturing the same

(75) Inventors: Won-Kyu Jeung, Seoul (KR); Sung Yi, Suwon-si (KR); Jae-Hyuk Jang, Seoul (KR); Jae-Hyoung Gil, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/453,313

(22) Filed: May 6, 2009

(30) Foreign Application Priority Data
Jun. 9, 2008 (KR) 10-2008-0053690

(51) Int. Cl. H01M 8/10; H01M 4/04

(52) U.S. Cl. 429/30; 29/623.1

(57) ABSTRACT

Disclosed are a fuel cell and a method for manufacturing the fuel cell. The fuel cell can include forming a channel on one surface of a first wafer and one surface of a second wafer, respectively; stacking a membrane electrode assembly on one surface of the first wafer; and coupling the second wafer to the first wafer to allow one surface of the second wafer to cover the membrane electrode assembly, to thereby manufacture the fuel cell in a small size at low cost, precisely form the membrane electrode assembly, and prevent a damage of the membrane electrode assembly.

### CROSS-REFERENCE TO RELATED APPLICATIONS

This application claims the benefit of Korean Patent Application No. 10-2008-0053690 filed with the Korean Intellectual Property Office on Jul. 9, 2008, the disclosure of which is incorporated herein by reference in its entirety.

### BACKGROUND

1. Technical Field

The present invention relates to a fuel cell and a method for manufacturing the fuel cell.

2. Description of the Related Art

The fuel cell is classified into various types such as a polymer electrolyte membrane fuel (PEMFC), a direct methanol fuel cell (DMFC), a molt carbonate fuel cell (MCFC), a solid oxide fuel cell (SOFC), phosphoric acid fuel cell (PAFC), and an alkaline fuel cell (AFC). In particular, the DMFC and the PEMFC are popular as portable small fuel cells.

While the DMFC is directly applied to a fuel cell without the process that converts methanol fuel to hydrogen and has low energy density, the PEMFC has high energy density and needs the process that converts fuel to hydrogen or directly uses the hydrogen having large volume as fuel.

In other words, the DMFC has a large system due to its low energy density, and the PEMFC also has a large system due to a device for converting fuel to hydrogen or its peripheral devices.

Accordingly, the micro electro mechanical system (MEMS) technology can be applied in order to reduce the overall size of the fuel cell. The MEMS technology makes it possible to manufacture the fuel cell with its efficiently reduced size by decreasing the thickness of end plates, maintaining constant coupling pressure between the end plates, and using no fastening means such as bolts.

However, when a fuel cell is manufactured by using the MEMS technology, it is not easy to form a membrane electrode assembly, which is the most sensitive part of the fuel cell. In other words, an electrode of the membrane electrode assembly has physical characteristics that are totally varied according to its pore structure, thickness, or density, and accordingly corresponding professional equipment must be adequate for the manufacturing method and purpose. However, it requires great efforts to link the equipment to the MEMS process.

Moreover, when a pair of end plates wafer-bond with each other after the membrane electrode assembly is formed, the temperature may be incased to several hundreds degrees Celsius. This may damage the membrane electrode assembly.

### SUMMARY

The present invention provides a method for manufacturing a fuel cell that can prevent the damage of a precisely formed membrane electrode assembly and be manufactured in small size at low cost.

The present invention also provides a fuel cell that can prevent a leak of fuel and oxygen, thereby improving electricity generation efficiency.

An aspect of the invention features a method for manufacturing a fuel cell including forming a channel on one surface of a first wafer and one surface of a second wafer, respectively; stacking a membrane electrode assembly on one surface of the first wafer; and coupling the second wafer to the first wafer to allow one surface of the second wafer to cover the membrane electrode assembly.

The method can further include forming a sealing layer on one surface of at least one of the first wafer and the second wafer in order to prevent a leak of a fluid flowed to the channel, before the stacking the membrane electrode assembly.

The forming the sealing layer can include forming a photosensitive material layer on one surface of at least one of the first wafer and the second wafer; and removing an area corresponding to the channel in the photosensitive material layer by emitting a ray of light.

The method can further include attaching the membrane electrode assembly to a supporting wafer, before the stacking the membrane electrode assembly, and removing the supporting wafer, after the stacking the membrane electrode assembly.

The supporting wafer can be made of a transparent material

The coupling the second wafer to the first wafer can be performed by a low temperature wafer bonding method in order to prevent a damage of the membrane electrode assembly.

Another aspect of the invention features a fuel including a first wafer, having one surface being formed with a first channel; a membrane electrode assembly, being stacked on one surface of the first wafer; a second wafer, being coupled to the first wafer such that one surface of the second wafer on which a second channel is to be formed covers the membrane electrode assembly; and a sealing layer, being interposed between the membrane electrode assembly and at least one of the first wafer and second wafer in order to prevent a leak of a fluid flowed to the first channel and the second channel.

The sealing layer can be made of a transparent material

### BRIEF DESCRIPTION OF THE DRAWINGS

FIG. 1 is a flowchart showing a method for manufacturing a fuel cell in accordance with an embodiment of the present invention;

FIG. 2 through FIG. 10 are sectional views showing each process of a method for manufacturing a fuel cell in accordance with an embodiment of the present invention;

FIG. 11 is a sectional view showing a fuel cell in accordance with an embodiment of the present invention; and

FIG. 12 is an exploded perspective view showing a fuel cell in accordance with an embodiment of the present invention.

### DETAIL DESCRIPTION

A fuel cell and a method for manufacturing the fuel cell according to certain embodiments of the invention will be described below in more detail with reference to the accompanying drawings. Those elements that are the same or are in correspondence are rendered the same reference numeral regardless of the figure number, and redundant explanations can be omitted.

Terms such as “first” and “second” can be used in describing various elements, but the above elements shall not be restricted to the above terms. The above terms are used only to distinguish one element from the other.

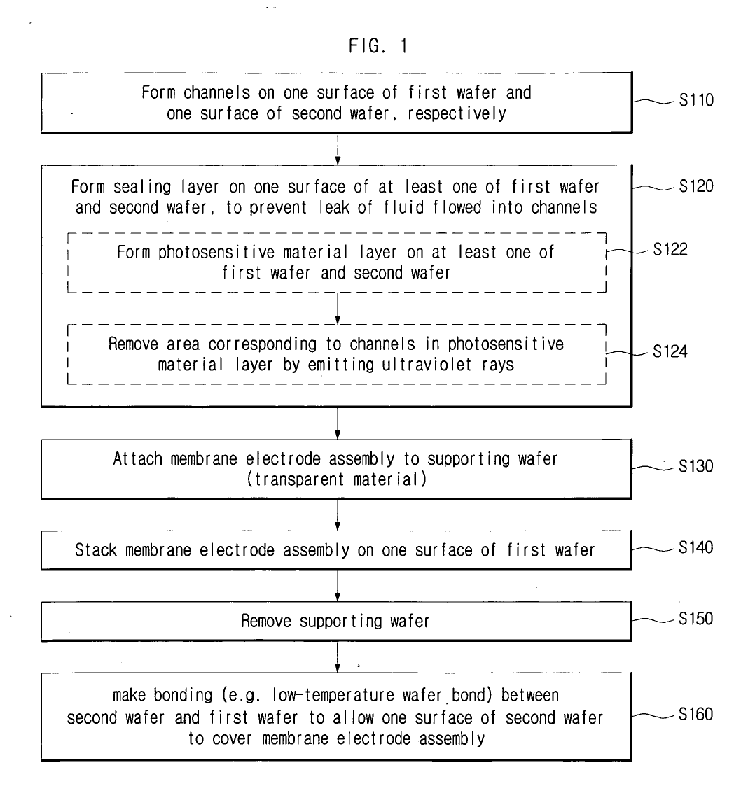

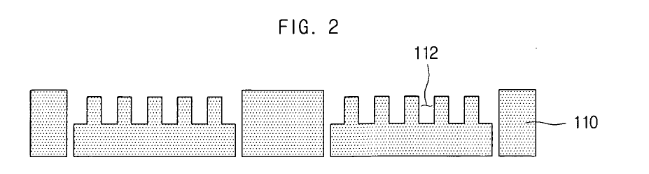

FIG. 1 is a flowchart showing a method for manufacturing a fuel cell in accordance with an embodiment of the present invention, and FIG. 2 through FIG. 10 are sectional views showing each process of a method for manufacturing a fuel cell in accordance with an embodiment of the present invention.

In accordance with an embodiment of the present invention, a method for manufacturing the fuel cell 100 can include processes of forming channels 112 and 122 on one surface of a first wafer 110 and one surface of a second wafer 120, respectively; stacking a membrane electrode assembly 140 on one surface of the first wafer 110; and coupling the second wafer 120 to the first wafer 110 such that one surface of the second wafer 120 covers the membrane electrode assembly 140, to thereby manufacture the fuel cell in a small size at low cost, form the membrane electrode assembly 140 precisely, and prevent any damage of the membrane electrode assembly 140 in a corresponding process.

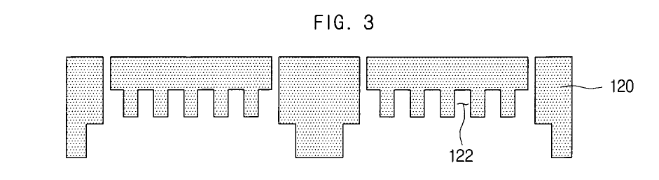

Firstly, as shown in FIG. 2 and FIG. 3, the channels 112 and 122 can be formed on one surface of the first wafer 110 and one surface of the second wafer 120, respectively, in a process represented by S110. In particular, the micro electro mechanical system (MEMS) can form each of the first channel 112 and the second channel 122 by removing a part of one surface of the first wafer 110 and a part of one surface of the second wafer 120, respectively, by use of an etching method.

The first channel 112 and the second channel 122 can be supplied with fuel, such as hydrogen, and oxygen, and the fuel and oxygen flowed to the first channel 112 and the second channel 122 can be supplied to an anode and a cathode of the membrane electrode assembly 140. This can generate electrical energy.

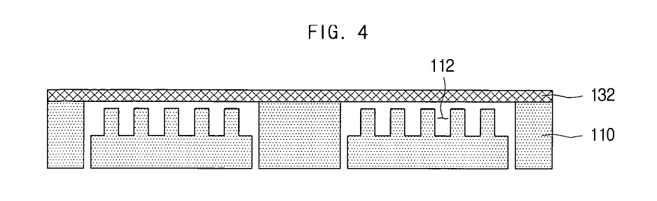

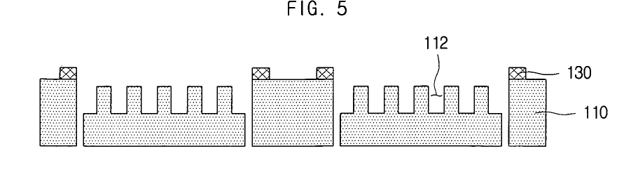

Then, as shown in FIG. 4 and FIG. 5, a sealing layer 130 can be formed on one surface of at least one of the first wafer 110 and the second wafer 120, to prevent a leak of fluids flowed to the channels 112 and 122 in a process represented by S120. As descried above, since fluids such as fuel and oxygen flow to the first channel 112 and the second channel 122, the sealing layer 130 can be formed to prevent a leak of the fluids before the membrane electrode assembly 140 is stacked.

Thereafter, the membrane electrode assembly 140 can be stacked, and the first wafer 110 and the second wafer 120 can bond with each other. This can result in interposing the sealing layer 130 between the first wafer 110 and the membrane electrode assembly 140, thereby prevent the fluids flowed to the first channel 112 and the second channel 122 from being mixed or from leaking to the outside.

The process of forming the sealing layer 130 can be divided into the following subprocesses.

Firstly, as shown in FIG. 4, a photosensitive material layer 132 can be formed on one surface of at least one of the first wafer 110 and the second wafer 120 in a process represented by S122. A dry film, for example, can be used as the photosensitive material layer 132. Then, as shown FIG. 5, areas corresponding to the channels 112 and 122 in the photosensitive material layer 132 can be removed by emitting rays of light, such as ultraviolet rays.

Since the process of exposing and developing the photosensitive material layer 132 is performed in the MEMS process and this can have no effect on its prior or following processes and the properties of another element, it can be possible to more stably and efficiently seal the first channel 112 and the second channel 122 as compared with the case of forming the sealing layer 130 by using an additional adhesive material.

Although the sealing layer 130 is formed on one surface of the first wafer 110 in an embodiment of the present invention, other modifications are possible without departing the scope of claims of the present invention. For example, the sealing layer 130 can be formed on one surface of the second wafer 120 or on one surface of the first wafer 110 and one surface of the second wafer, respectively.

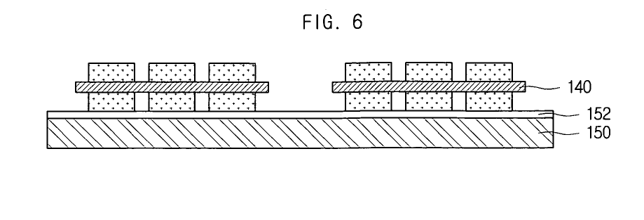

Then, as shown in FIG. 6, the membrane electrode assembly 140 can be attached to a supporting wafer (i.e. a transparent material) in a process represented by S130. After the membrane electrode assembly 140 is precisely formed independently of the MEMS process, the flexible membrane electrode assembly 140 can be attached to the supporting wafer 150 in order to make it easy to stack the membrane electrode assembly 140 on one surface of the first wafer 110.

At this time, the supporting wafer 150 can be made of a transparent material such as glass. Accordingly, the supporting wafer 150 can support the flexible membrane electrode assembly 140. Moreover, when the membrane electrode assembly 140 supported by the supporting wafer 150 is stacked on the first wafer 110, the membrane electrode assembly 140 and the first wafer 110 can be accurately aligned in the other surface, which is the opposite side of the surface, to which the membrane electrode assembly 140 is attached. This can make it possible to more efficiently and efficiently to stack the membrane electrode assembly 140 on the first wafer 110.

In addition, an adhesive layer 152 can be formed on one surface of the supporting wafer, to which the membrane electrode assembly 140 is to be attached, thereby attaching the membrane electrode assembly 140 more efficiently.

Here, the membrane electrode assembly 140 can convert chemical energy to electrical energy and include an anode, a cathode, and an electrolyte membrane interposed therebetween. Below described in detail are the electrolyte membrane, the anode, and the cathode.

The electrolyte membrane can be interposed between the anode and the cathode and move hydrogen ions generated by an oxidation reaction at the anode to the cathode. It can be also possible to use a polymer material.

In particular, the anode can be formed on one surface of the electrolyte membrane and be supplied with a fuel such as hydrogen or methanol, and then can undergo an oxidation reaction at a catalyst layer of the anode to generate hydrogen ions and electrons. The cathode can be formed on the other surface of the electrolyte membrane and be supplied with oxygen and the electrons generated at the anode, and then can undergo a reduction reaction at the catalyst layer of the cathode to generate oxygen ions.

The anode and the corresponding cathode can generate electrical energy through the chemical reactions as shown in the following reaction schemes 1 and 2 according to the type of the fuel. Here, the reaction scheme 1 is related to hydrogen, and the reaction scheme 2 is related to methanol.

### [Reaction Scheme 1]

Anode: H₂→2H⁺+2e⁻

Cathode: O₂+4H⁺+4e⁻→2H₂O

Overall Reaction: 2H₂+O₂→2H₂O

### [Reaction Scheme 2]

Anode: CH₃OH+H₂O→CO₂+6H⁺+6e⁻

Cathode: 1.5O₂+6H⁺+6e⁻→3H₂O

Overall Reaction: CH₃OH+1.5O₂→CO₂+2H₂O

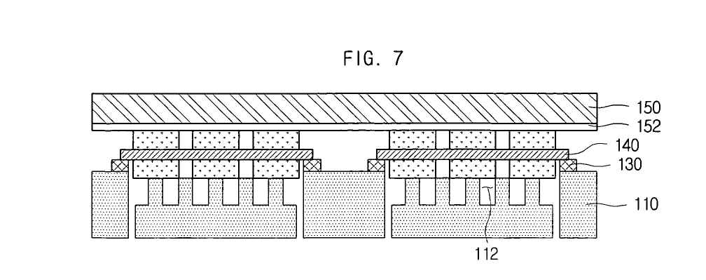

Then, as shown in FIG. 7, the membrane electrode assembly 140 can be stacked on one surface of the first wafer 110 in a process represented by S140. As such, the membrane electrode assembly 140 can be manufactured independently of the MEMS process, which makes the first wafer 110 and the second wafer 120. The manufactured membrane electrode assembly 140 can be staked on the first wafer 110 by using the supporting wafer 150. Accordingly, the membrane electrode assembly 140 can be more precisely and efficiently formed to be more adequate for its desired properties as compared with the method of forming the membrane electrode assembly 140 in the MEMS process.

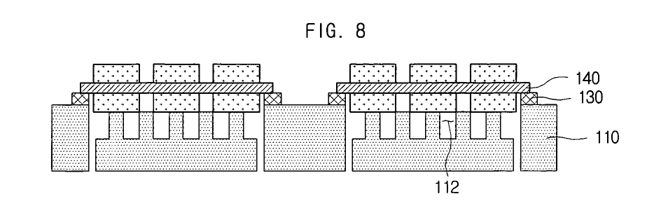

Thereafter, as shown in FIG. 8, the supporting wafer 150 can be removed in a process represented by S150. In particular, after the membrane electrode 140 is stacked on the first wafer 110, the supporting wafer 150, which is not necessary any more, can be removed such that the second wafer 120 can bond with the first wafer 110.

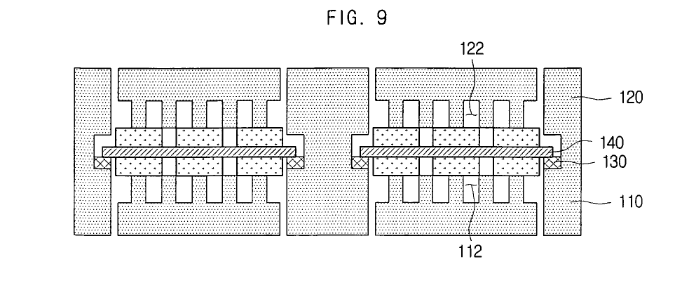

Then, as shown in FIG. 9, the bonding (e.g. low temperature wafer bonding) can be made between the second wafer 120 and the first wafer 110 to allow one surface of the second wafer 120 to cover the membrane electrode assembly 140 in a process represented by S160. In particular, the surface on which the second channel 122 is formed can be arranged to cover the membrane electrode assembly 140, and the bonding can be made between the second wafer 120 and the first wafer 110 by a low-temperature wafer bonding method.

If the membrane electrode assembly 140 is exposed to the temperature of 175 or more degree Celsius, the membrane electrode assembly 140 may be deteriorated and its properties may be significantly depreciated. Accordingly, the low temperature wafer bonding can be made between the first wafer 110 and the second wafer 120 in order to prevent a damage of the membrane electrode assembly 140.

Here, the low temperature wafer bonding can be made by performing the surface treatment or the surface activation of the first wafer 110 and the second wafer 120.

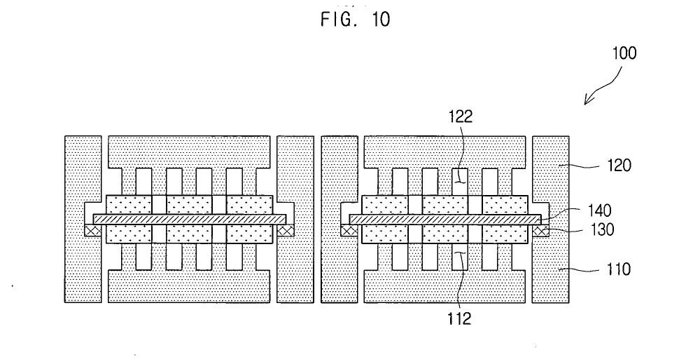

Then, as shown in FIG. 10, the fuel cell 100 can be severed into individual units to make unit fuel cells.

Hereinafter, a fuel cell will be described in accordance with an embodiment of the present invention.

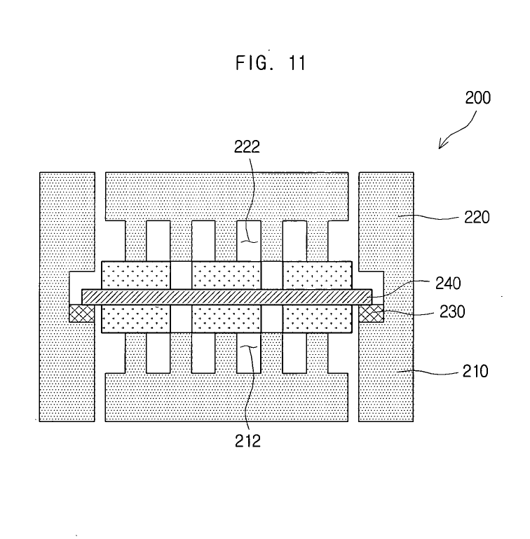

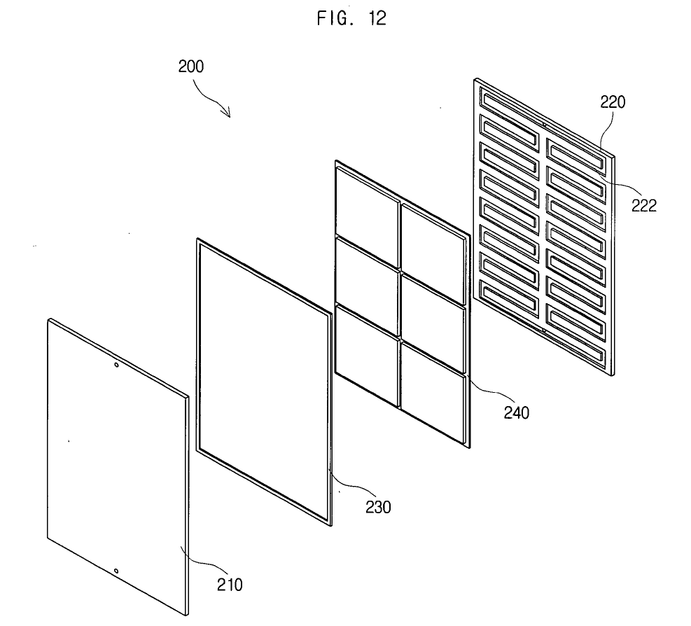

FIG. 11 is a sectional view showing a fuel cell in accordance with an embodiment of the present invention, and FIG. 12 is an exploded perspective view showing a fuel cell in accordance with an embodiment of the present invention.

In accordance with an embodiment of the present invention, the fuel cell 200 can be suggested to include a first wafer 210, having one surface being formed with a first channel 212, a membrane electrode assembly 240, being stacked on one surface of the first wafer 210, a second wafer 220, having one surface being formed with a second channel 222, and being coupled to the first wafer 210 such that the surface on which the second channel 22 is formed can cover the membrane electrode assembly 240, and a sealing layer 230, interposed between the membrane electrode assembly 240 and at least one of the first wafer 210 and the second wafer 220, to thereby prevent a leak of fuel or oxygen flowed to the channels 212 and 222. This can improve the electricity generation efficiency.

The first wafer 210, which corresponds to an end plate of the fuel cell 200, can have one surface being formed with the first channel 212 to which a fuel is supplied. As described n the aforementioned embodiment of the present invention, the first channel 212 can be formed by etching one surface of the first wafer 210 made of silicon by the MEMS technology, and the fuel supplied to the channel 212 can be provided to the membrane electrode assembly 240 and react to oxygen supplied to the second channel 222 of the second wafer 220, to thereby generate electrical energy.

The membrane electrode assembly 240 can be made of an anode, a cathode, and an electrolyte membrane interposed therebetween and be stacked one surface of the first wafer 210, and the sealing layer 230 can be interposed between the first wafer 210 and the membrane electrode assembly 240. Since the membrane electrode assembly 240 has already been described in detail in the aforementioned embodiment of the present invention, the description related to the structure and the functions of the membrane electrode assembly 240 will be omitted, and the sealing layer 230 will be described below.

The membrane electrode assembly 240 may not be manufactured by the MEMS process like the first wafer 210 and the second wafer 220. Instead, the membrane electrode assembly 240 can be manufactured by using a separate process, and then the membrane electrode assembly 240 can be stacked on the first wafer 210. Accordingly, the membrane electrode assembly 240 can perform its more improved functions as compared with being formed by the MEMS process.

As described in the foresaid embodiment of the present invention, the membrane electrode assembly 240 can be efficiently stacked on the first wafer by using a supporting wafer. The pertinent detailed description will be omitted.

The second wafer 220, which corresponds to an end plate of the fuel cell 200 like the first wafer 210, can be coupled to the first wafer 210 to allow the surface on which the second channel 222 is formed to cover the membrane electrode assembly 240. Similar to the first wafer 210, the second wafer 220 can be made of silicon and have one surface being formed with the second channel 222 by the MEMS technology.

In particular, the second wafer 220 can be coupled to the first wafer 210 by the low temperature wafer bonding method in order to allow the surface on which the second channel 222 is formed to cover the membrane electrode assembly 240, thereby prevent a damage of the membrane electrode assembly 240 in the bonding.

Since the bonding made between the first wafer 210 and the second wafer 220 has been described in the aforementioned embodiment of the present invention, the pertinent detailed description will be omitted.

The sealing layer 230 can be interposed between the membrane electrode assembly 240 and at least one of the first wafer 210 and the second wafer 220, to prevent a leak of fluids flowed to the first channel 212 and the second channel 222. In other words, interposing the sealing layer 230 between the first wafer 210 and the membrane electrode assembly 240 can make it possible to prevent the fluids flowed to the first channel 212 and the second channel 222 from being mixed or from leaking to the outside, thereby improving the electricity generation efficiency of the fuel cell 200.

The sealing layer 230 can be made of a photosensitive material. As described in the foregoing embodiment of the present invention, in the MEMS process, a photosensitive material layer such as a dry film can be formed on one surface of the first wafer 210, and the sealing layer 230 can be formed by the exposure and development. Since this can have no effect on its prior or following processes and the properties of another element, it can be possible to more stably and efficiently seal the first channel 212 and the second channel 222 as compared with the case of forming the sealing layer 230 by using an additional adhesive material.

Although the sealing layer 230 is formed between the first wafer 210 and the membrane electrode assembly 230 in an embodiment of the present invention, other modifications are possible without departing the scope of claims of the present invention. For example, the sealing layer 230 can be formed between the second wafer 220 and the membrane electrode assembly 240 or between the first wafer 210 and the membrane electrode assembly 240 and between the second wafer 220 and the membrane electrode assembly 240, respectively.

Many embodiments other than those set forth above can be found in the appended claims.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A fuel cell manufacturing method, comprising:
forming a channel on one surface of a first wafer and one surface of a second wafer, respectively;
stacking a membrane electrode assembly on one surface of the first wafer; and
coupling the second wafer to the first wafer to allow one surface of the second wafer to cover the membrane electrode assembly.

2. The method of claim 1, further comprising: forming a sealing layer on one surface of at least one of the first wafer and the second wafer in order to prevent a leak of a fluid flowed to the channel,
before the stacking the membrane electrode assembly.

3. The method of claim 2, wherein the forming the sealing layer comprises
forming a photosensitive material layer on one surface of at least one of the first wafer and the second wafer; and
removing an area corresponding to the channel in the photosensitive material layer by emitting a ray of light.

4. The method of claim 1, further comprising: attaching the membrane electrode assembly to a supporting wafer, before the stacking the membrane electrode assembly, and
removing the supporting wafer, after the stacking the membrane electrode assembly.

5. The method of claim 4, wherein the supporting wafer is made of a transparent material.

6. The method of claim 1, wherein the coupling the second wafer to the first wafer is performed by a low temperature wafer bonding method in order to prevent a damage of the membrane electrode assembly.

7. A fuel cell, comprising:
a first wafer, having one surface being formed with a first channel;
a membrane electrode assembly, being stacked on one surface of the first wafer;
a second wafer, being coupled to the first wafer such that one surface of the second wafer on which a second channel is to be formed covers the membrane electrode assembly; and
a sealing layer, being interposed between the membrane electrode assembly and at least one of the first wafer and second wafer in order to prevent a leak of fluids flowed to the first channel and the second channel.

8. The fuel cell of claim 7, wherein the sealing layer is made of a photosensitive material.
